(19) United States
(12) Patent Application Publication
(10) Pub. No.: US 2009/0216946 A1
(43) Pub. Date: Aug. 27, 2009

(54) RAID1 SYSTEM AND READING METHOD FOR ENHANCING READ PERFORMANCE

(76) Inventor: Zhi-Ming Sun, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/126,913

(22) Filed: May 25, 2008

(30) Foreign Application Priority Data
Feb. 22, 2008 (TW) 097106251

(51) Int. Cl. G06F 12/00

(52) U.S. Cl. 711/114; 711/E12.001

(57) ABSTRACT

Concerning the operations of a redundant array of independent disks 1 system, a reading process is carried out by skipping the even-address storage units in a first storage device, sequentially fetching the data of the odd-address storage units in the first storage device for forming a first data stream, skipping the odd-address storage units in a second storage device, sequentially fetching the data of the even-address storage units in the second storage device for forming a second data stream, and merging the first data stream and the second data stream for generating a readout data stream.

### BACKGROUND OF THE INVENTION

1. Field of the Invention

The present invention relates to a RAID1 System and reading method, and more particularly, to a RAID1 System and reading method for enhancing read performance.

2. Description of the Prior Art

Due to the need for mass data processing and fast data exchanging, how to build a storage system having high availability, high performance and high volume has become an important issue for related field. Currently, most of the existing computer systems make use of the redundant array of independent disks (RAID) system as a storage system in that the RAID system is able to provide memory space having desirable features to the host entity.

Based on the operation mode of the RAID system, the RAID system can be categorized into RAID-level 0, 1, 2, 3, 4, 5, 6, and 7, etc. Generally, most of the existing computer operating systems are capable of operating the computer system attached with the RAID-level 0 or 1 system. The computer system attached with other RAID systems can only be operated with the support of certain add-on disc drive controllers. Accordingly, among a variety of different storage systems applied to the computer systems having low system complexity, the RAID-level 0 and 1 systems are known as the most popular options for providing the high availability, high performance and high volume memory space to the computer systems.

Concerning the RAID0 system, the stored data are distributed in a plurality of storage devices of the RAID0 system, and the data reading and writing processes are performed based on parallel processing for achieving high accessing performance. However, the RAID0 system is not equipped with any data storage protection mechanism. That is, if any storage device of the RAID0 system is failed, then the data stored in the RAID0 system cannot be fetched anymore.

Concerning the RAID1 system, both the two storage devices of the RAID1 system store same data. That is, the data writing process is performed on both storage devices for writing same data, and the data reading process can be performed on either storage device. Accordingly, if one of the two storage devices fails, then the data stored in the RAID1 system can be fetched from the other one of the two storage devices. After the failed storage device is replaced with a new storage device, the new storage device can backup data from the working storage device. For that reason, the RAID1 system is able to provide 1:1 data storage protection mechanism under low system complexity and becomes the most popular storage system. However, the maximum amount of data stored in the RAID1 system is only fifty percents of the physical memory size of the RAID1 system.

Please refer to FIG. 1, which is a functional block diagram schematically showing a prior-art RAID1 system 100. The RAID1 system 100 comprises a RAID controller 120 coupled to a host 110 and a RAID 180 coupled to the RAID controller 120. The RAID 180 comprises two hard disc drives 183 and 186. The RAID controller 120 comprises a bus interface 130 coupled to the host 110, a central processing unit 140 coupled to the bus interface 130, and a data register unit 150 coupled to the central processing unit 140. In general, a RAID creation process should be performed on the RAID1 system 100 for setting configuration and initializing the RAID 180 for the host 110 so that the RAID 180 can be available to the host 110 and can be accessed by the host 110.

In the process of writing the data from the host 110 to the RAID 180, the RAID controller 120 performs a data transferring process for transferring the data from the host 110 to both hard disc drives 183 and 186. In the process of reading the data from the RAID 180 to the host 110, the RAID controller 120 firstly detects whether both the hard disc drives 183 and 186 are working. If both the hard disc drives 183 and 186 are working, then the readout data are sequentially fetched from either of the hard disc drives 183 and 186. If the hard disc drive 183 is failed and the hard disc drive 186 is working, then the readout data can be sequentially fetched from the hard disc drive 186. If the hard disc drive 186 is failed and the hard disc drive 183 is working, then the readout data can be sequentially fetched from the hard disc drive 183. That is, the writing process is performed by writing same data from the host 110 to both the hard disc drives 183 and 186, and the reading process is performed by reading data from one working hard disc drive. Accordingly, the access performance of the RAID1 system is inferior to the access performance of the RAID0 system based on parallel processing.

### SUMMARY OF THE INVENTION

In accordance with an embodiment of the present invention, a RAID1 System for enhancing read performance is provided. The RAID1 system comprises a RAID1 controller, a first storage device, and a second storage device. The first storage device is coupled to the RAID1 controller. The first storage device comprises a read device for receiving an odd-address data read command and performing the odd-address data read command by skipping even-address data stored in the first storage device and sequentially fetching odd-address data stored in the first storage device. The second storage device is coupled to the RAID1 controller. The second storage device comprises a read device for receiving an even-address data read command and performing the even-address data read command by skipping odd-address data stored in the second storage device and sequentially fetching even-address data stored in the second storage device.

The present invention further provides a storage device for use in a RAID1 system. The storage device comprises a storage medium and a read device. The read device can be utilized for receiving an odd-address data read command and performing the odd-address data read command by skipping even-address data stored in the storage medium and sequentially fetching odd-address data stored in the storage medium based on a data storage unit as a base reading unit. Alternatively, the read device can be utilized for receiving an even-address data read command and performing the even-address data read command by skipping odd-address data stored in the storage medium and sequentially fetching even-address data stored in the storage medium based on the data storage unit as a base reading unit. Also, the read device can be utilized for receiving a general data read command and performing the general data read command by sequentially fetching data stored in the storage medium based on the data storage unit as a base reading unit. The data storage unit is the data stored in a preset sectioned memory space of the storage medium.

The present invention further provides a RAID1 reading method for enhancing read performance. The RAID1 reading method comprises forwarding an odd-address data read command to a first storage device, forwarding an even-address data read command to a second storage device, the first storage device performing the odd-address data read command by skipping even-address data stored in the first storage device and sequentially fetching odd-address data stored in the first storage device for forming a first data stream, the second storage device performing the even-address data read command by skipping odd-address data and sequentially fetching even-address data stored in the second storage device for forming a second data stream, and performing a data aggregation process on the first data stream and the second data stream for generating a readout data stream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram schematically showing a prior-art RAID1 system.

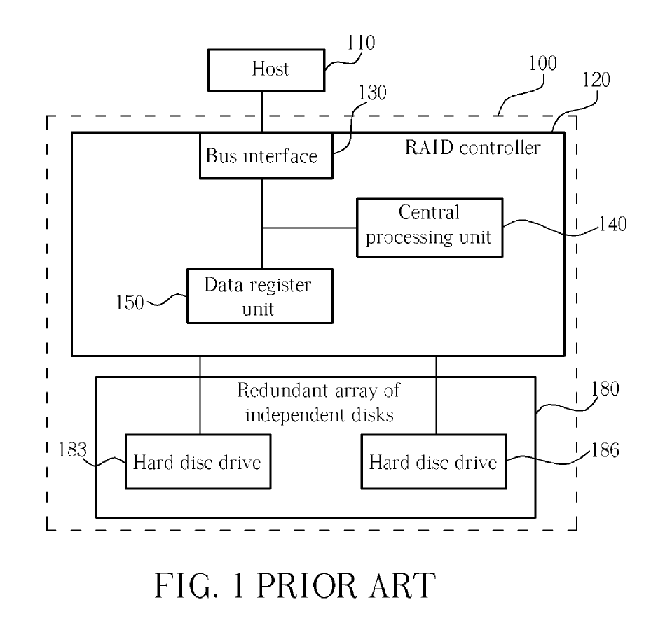

FIG. 2 is a functional block diagram schematically showing a RAID1 system in accordance with an embodiment of the present invention.

FIG. 3 is a flowchart depicting a RAID1 reading method based on the RAID1 system in FIG. 2 according to the present invention.

### DETAILED DESCRIPTION

Hereinafter, preferred embodiments of the present invention will be described in detail with reference to the accompanying drawings. Here, it is to be noted that the present invention is not limited thereto. Furthermore, the step serial numbers concerning the RAID1 reading method for enhancing read performance are not meant thereto limit the operating sequence, and any rearrangement of the operating sequence for achieving same functionality is still within the spirit and scope of the invention.

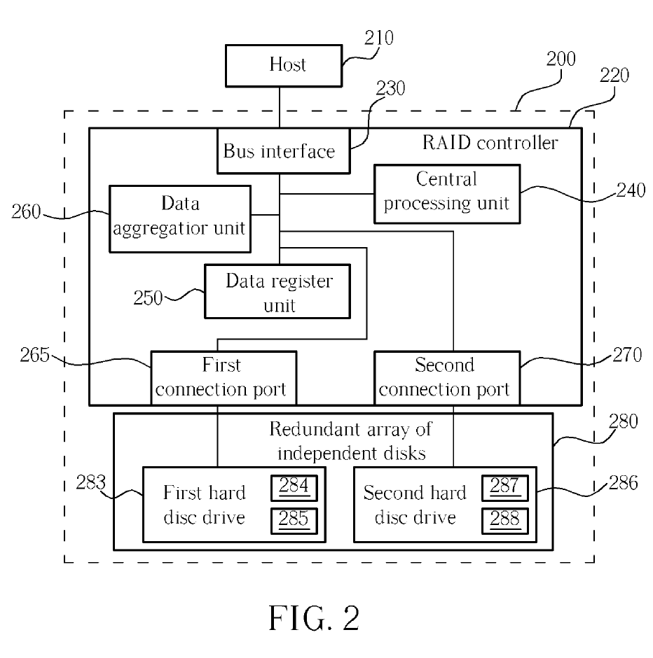

Please refer to FIG. 2, which is a functional block diagram schematically showing a RAID1 system 200 in accordance with an embodiment of the present invention. The RAID1 system 200 comprises a RAID controller 220 and a RAID 280 coupled to the RAID controller 220. The RAID 280 comprises a first hard disc drive 283 and a second hard disc drive 286. The first hard disc drive 283 comprises a read device 284 and a disc 285. The second hard disc drive 286 comprises a read device 287 and a disc 288.

The RAID controller 220 comprises a bus interface 230, a central processing unit 240 coupled to the bus interface 230, a data register unit 250 coupled to the central processing unit 240, a data aggregation unit 260 coupled to the data register unit 250, a first connection port 265 coupled to the central processing unit 240, and a second connection port 270 coupled to the central processing unit 240. In the RAID1 system 200, the first connection port 265 is also coupled to the first hard disc drive 283, and the second connection port 270 is also coupled to the second hard disc drive 286. The bus interface 230 can be coupled to a host 210.

The bus interface 230 can be a serial advanced technology attachment (SATA) interface, a universal serial bus (USB) interface, a serial attached small computer system interface (SAS, serial attached SCSI), an IEEE-1394 interface, or an eSATA interface. The first connection port 265 can be a SATA interface connection port, an USB interface connection port, a SAS connection port, an IEEE-1394 interface connection port, or an eSATA interface connection port. Also, the second connection port 270 can be a SATA interface connection port, an USB interface connection port, a SAS connection port, an IEEE-1394 interface connection port, or an eSATA interface connection port. The first hard disc drive 283 can be a SATA hard disc drive or a SAS hard disc drive. Also, the second hard disc drive 286 can be a SATA hard disc drive or a SAS hard disc drive.

The read commands provided by the central processing unit 240 comprise a general data read command, an odd-address data read command, and an even-address data read command. The read commands performed by the read device 284 of the first hard disc drive 283 comprise the general data read command, the odd-address data read command, and the even-address data read command. Also, the read commands performed by the read device 287 of the second hard disc drive 286 comprise the general data read command, the odd-address data read command, and the even-address data read command. The odd-address data read command and the even-address data read command can be processed based on a data storage unit as a base reading unit. Please note that the data storage unit is the data stored in the preset sectioned memory space of storage devices. For instance, based on the hard disc drives as the storage devices in the embodiment shown in FIG. 2, if the sectioned memory space of a data storage unit comprises one sector, then the odd-address data are corresponding to the data stored in the first sector, the third sector, and the fifth sector, etc., and the even-address data are corresponding to the data stored in the second sector, the fourth sector, and the sixth sector, etc. Alternatively, if the sectioned memory space of a data storage unit comprises two sectors, then the odd-address data are corresponding to the data stored in the first and second sectors, the fifth and sixth sectors, and the ninth and tenth sectors, etc., and the even-address data are corresponding to the data stored in the third and fourth sectors, the seventh and eighth sectors, and the eleventh and twelfth sectors, etc.

When the host 210 is ready to access the data stored in the RAID 280 and the first hard disc drive 283 is detected as a failed hard disc drive, the RAID controller 220 sends a general data read command to the read device 287 of the second hard disc drive 286 so that the read device 287 is able to sequentially fetch the data stored in the disc 288. Similarly, when the host 210 is ready to access the data stored in the RAID 280 and the second hard disc drive 286 is detected as a failed hard disc drive, the RAID controller 220 sends a general data read command to the read device 284 of the first hard disc drive 283 so that the read device 284 is able to sequentially fetch the data stored in the disc 285.

When the read device 284 of the first hard disc drive 283 receives an odd-address data read command from the RAID controller 220, the reading process performed by the read device 284 is carried out by skipping the even-address data and sequentially fetching the odd-address data of the disc 285 based on the data storage unit as a base reading unit. When the read device 284 of the first hard disc drive 283 receives an even-address data read command from the RAID controller 220, the reading process performed by the read device 284 is carried out by skipping the odd-address data and sequentially fetching the even-address data of the disc 285 based on the data storage unit as a base reading unit.

Likewise, when the read device 287 of the second hard disc drive 286 receives an odd-address data read command from the RAID controller 220, the reading process performed by the read device 287 is carried out by skipping the even-address data and sequentially fetching the odd-address data of the disc 288 based on the data storage unit as a base reading unit. When the read device 287 of the second hard disc drive 286 receives an even-address data read command from the RAID controller 220, the reading process performed by the read device 287 is carried out by skipping the odd-address data and sequentially fetching the even-address data of the disc 288 based on the data storage unit as a base reading unit.

That is, when the host 210 is ready to access the data stored in the RAID 280 and both the first hard disc drive 283 and the second hard disc drive 286 are working, the central processing unit 240 of the RAID controller 220 sends an odd-address data read command and an even-address data read command to the read device 284 of the first hard disc drive 283 and the read device 287 of the second hard disc drive 286 respectively. Accordingly, the read device 284 performs a reading process by skipping the even-address data of the disc 285 and sequentially fetching the odd-address data of the disc 285 for forming a first data stream based on the data storage unit as a reading unit, and the read device 287 performs a reading process by skipping the odd-address data of the disc 288 and sequentially fetching the even-address data of the disc 288 for forming a second data stream based on the data storage unit as a reading unit. The first data stream and the second data stream are sequentially stored in the data register unit 250, and the data aggregation unit 260 sequentially merges the first data stream and the second data stream for generating a readout data stream. The readout data stream is then forwarded to the host 210.

In another embodiment, the central processing unit 240 can also be utilized to perform a data aggregation process for generating the readout data stream by merging the first data stream and the second data stream. That is, the data aggregation unit 260 can be omitted. However, with the aid of the data aggregation unit 260 for performing the data aggregation process in the RAID controller 220, the data processing efficiency of the RAID controller 220 can be enhanced. Especially when dealing with mass data accessing or multitasking, the operating performance of the central processing unit 240 can be enhanced significantly with the aid of the data aggregation unit 260 for providing auxiliary data processing. Besides, when the host 210 is ready to access the data stored in the RAID 280 and both the first hard disc drive 283 and the second hard disc drive 286 are working, the central processing unit 240 of the RAID controller 220 may send an even-address data read command and an odd-address data read command to the first hard disc drive 283 and the second hard disc drive 286 respectively for performing the aforementioned data accessing operation.

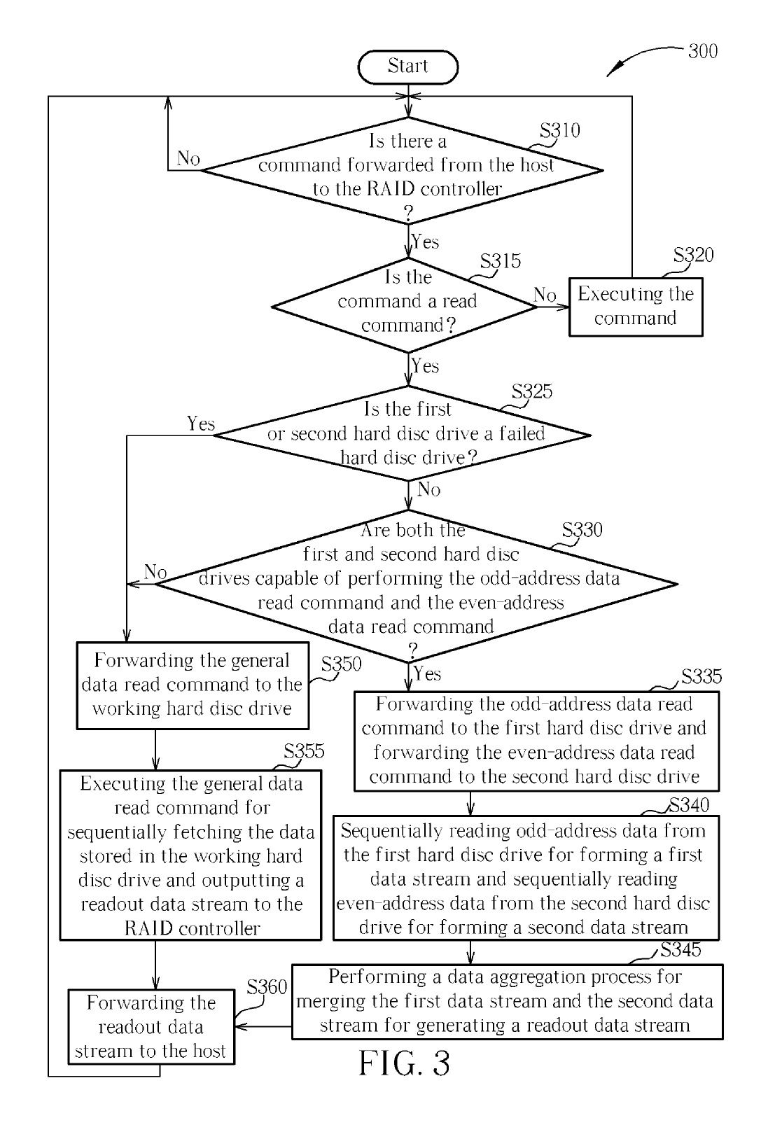

Please refer to FIG. 3, which is a flowchart depicting a RAID1 reading method 300 based on the RAID1 system 200 in FIG. 2 according to the present invention. The RAID1 reading method 300 is set forth by collocating the elements shown in FIG. 2 and the description detailed in the following steps:

Step S310: detecting whether the host 210 sends a command to the RAID controller 220, if the host 210 sends a command to the RAID controller 220, then go to step S315, else go to step S310;

Step S315: determining whether the command from the host 210 is a read command, if the command from the host 210 is a read command, then go to step S325, else go to step S320;

Step S320: executing the command from the host 210, go to step S310;

Step S325: detecting whether the first hard disc drive 283 or the second hard disc drive 286 is a failed hard disc drive, if the first hard disc drive 283 or the second hard disc drive 286 is a failed hard disc drive, then go to step S350, else go to step S330;

Step S330: detecting whether both the first hard disc drive 283 and the second hard disc drive 286 are capable of performing the odd-address data read command and the even-address data read command, if both the first hard disc drive 283 and the second hard disc drive 286 are capable of performing the odd-address data read command and the even-address data read command, then go to step S335, else go to step S350;

Step S335: forwarding the odd-address data read command to the first hard disc drive 283 and forwarding the even-address data read command to the second hard disc drive 286 by the RAID controller 220;

Step S340: sequentially reading odd-address data from the disc 285 for forming a first data stream forwarded to the RAID controller 220 by the read device 284 of the first hard disc drive 283 and sequentially reading even-address data from the disc 288 for forming a second data stream forwarded to the RAID controller 220 by the read device 287 of the second hard disc drive 286;

Step S345: performing a data aggregation process for merging the first data stream and the second data stream for generating a readout data stream by the RAID controller 220, go to step S360;

Step S350: forwarding the general data read command to the first hard disc drive 283 if the first hard disc drive 283 is working, or forwarding the general data read command to the second hard disc drive 286 if the second hard disc drive 286 is working;

Step S355: executing the general data read command for sequentially fetching the data of the disc 285 and outputting a readout data stream to the RAID controller 220 by the read device 284 of the first hard disc drive 283 if the first hard disc drive 283 is working, or executing the general data read command for sequentially fetching the data of the disc 288 and outputting a readout data stream to the RAID controller 220 by the read device 287 of the second hard disc drive 286 if the second hard disc drive 286 is working; and

Step S360: forwarding the readout data stream to the host 210 by the RAID controller 220, go to step S310.

In the flow of the RAID1 reading method 300, the process of the step S330 can be replaced as detecting whether the first hard disc drive 283 is capable of performing the odd-address read command and the second hard disc drive 286 is capable of performing the even-address read command, if the first hard disc drive 283 is capable of performing the odd-address read command and the second hard disc drive 286 is capable of performing the even-address read command, then go to step S335, else go to step S350.

The process of the step S340 may comprise skipping the even-address data and sequentially reading the odd-address data from the disc 285 for forming the first data stream forwarded to the RAID controller 220 by the read device 284 of the first hard disc drive 283 based on the data storage unit as a base reading unit, and skipping the odd-address data and sequentially reading the even-address data from the disc 288 for forming the second data stream forwarded to the RAID controller 220 by the read device 287 of the second hard disc drive 286 based on the data storage unit as a base reading unit.

The process of the step S350 comprises forwarding the general data read command to the first hard disc drive 283 by the RAID controller 220 if the second hard disc drive 286 is detected as a failed hard disc drive, or forwarding the general data read command to the second hard disc drive 286 by the RAID controller 220 if the first hard disc drive 283 is detected as a failed hard disc drive.

The process of the step S355 comprises executing the general data read command for sequentially fetching the data of the disc 285 and outputting the readout data stream to the RAID controller 220 by the read device 284 of the first hard disc drive 283 if the second hard disc drive 286 is detected as a failed hard disc drive, or executing the general data read command for sequentially fetching the data of the disc 288 and outputting a readout data stream to the RAID controller 220 by the read device 287 of the second hard disc drive 286 if the first hard disc drive 283 is detected as a failed hard disc drive.

Please note that in the aforementioned embodiment of the present invention, although the hard disc drives are used as the storage devices of the RAID1 system, the RAID1 system of the present invention is not limited thereto and other types of storage devices, such as a solid state drive (SSD) or an i-RAM based on double data rate random access memory (DDR-RAM), can also be installed in the RAID1 system of the present invention. Furthermore, the storage medium of the storage device can be a flash memory or a DDR-RAM instead of a disc.

In summary, the reading method of the RAID1 system of the present invention is performed based on the general data read command in conjunction with the novel odd-address and even-address data read commands. When both storage devices of the RAID1 system are working, the reading process is performed based on parallel processing by fetching the data from the two storage devices concurrently through executing the novel odd-address and even-address data read commands. That is, the reading performance of the RAID1 system of the present invention can be comparable to that of the RAID0 system. Accordingly, the RAID1 system of the present invention provides not only the 1:1 data storage protection mechanism but also the high reading performance. Although the writing performance of the RAID1 system of the present invention is not enhanced, the entire operating efficiency is substantially enhanced significantly in that the reading operation is performed much often than the writing operation for most of the system users.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A RAID1 system comprising:
a RAID1 controller;
a first storage device coupled to the RAID1 controller, the first storage device comprising a read device for receiving an odd-address data read command and performing the odd-address data read command by skipping even-address data stored in the first storage device and sequentially fetching odd-address data stored in the first storage device; and
a second storage device coupled to the RAID1 controller, the second storage device comprising a read device for receiving an even-address data read command and performing the even-address data read command by skipping odd-address data stored in the second storage device and sequentially fetching even-address data stored in the second storage device.

2. The RAID1 system of claim 1, wherein the odd-address data read command and the even-address data read command are performed based on a base reading unit having data stored in a preset sectioned memory space of the first storage device and the second storage device respectively.

3. The RAID1 system of claim 1, wherein the RAID1 controller comprises:
a central processing unit coupled to the first storage device and the second storage device; and
a data register unit coupled to the central processing unit.

4. The RAID1 system of claim 3, wherein the RAID1 controller further comprises:
a data aggregation unit coupled to the data register unit for performing a data aggregation process on the data fetched from the first storage device and the second storage device.

5. The RAID1 system of claim 3, wherein the RAID1 controller further comprises:
a bus interface coupled to the central processing unit.

6. The RAID1 system of claim 5, wherein the bus interface is a serial advanced technology attachment (SATA) interface, a universal serial bus (USB) interface, a serial attached small computer system interface (SAS, serial attached SCSI), an IEEE-1394 interface, or an eSATA interface.

7. The RAID1 system of claim 3, wherein the RAID1 controller further comprises:
a first connection port coupled between the first storage device and the central processing unit; and
a second connection port coupled between the second storage device and the central processing unit.

8. The RAID1 system of claim 7, wherein the first connection port is a SATA interface connection port, an USB interface connection port, a SAS connection port, an IEEE-1394 interface connection port, or an eSATA interface connection port.

9. The RAID1 system of claim 7, wherein the second connection port is a SATA interface connection port, an USB interface connection port, a SAS connection port, an IEEE-1394 interface connection port, or an eSATA interface connection port.

10. The RAID1 system of claim 1, wherein the first storage device is a SATA hard disc drive, a SAS hard disc drive, a solid state drive, or an i-RAM based on double data rate random access memory (DDR-RAM).

11. The RAID1 system of claim 1, wherein the second storage device is a SATA hard disc drive, a SAS hard disc drive, a solid state drive, or an i-RAM based on double data rate random access memory.

12. A storage device for use in a RAID1 system comprising:
a storage medium; and
a read device for receiving an odd-address data read command and performing the odd-address data read command by skipping even-address data stored in the storage medium and sequentially fetching odd-address data stored in the storage medium based on a data storage unit as a base reading unit;
wherein the data storage unit is the data stored in a preset sectioned memory space of the storage medium.

13. The storage device of claim 12, wherein the read device can be further utilized for receiving a general data read command and performing the general data read command by sequentially fetching data stored in the storage medium.

14. The storage device of claim 12, wherein the read device can be further utilized for receiving an even-address data read command and performing the even-address data read command by skipping odd-address data stored in the storage medium and sequentially fetching even-address data stored in the storage medium based on the data storage unit as a base reading unit.

15. The storage device of claim 12, wherein the storage device is a SATA hard disc drive, a SAS hard disc drive, a solid state drive, or an i-RAM based on double data rate random access memory.

16. The storage device of claim 12, wherein the storage medium is a disc, a flash memory, or a double data rate random access memory.

17. A RAID1 reading method comprising:
forwarding an odd-address data read command to a first storage device;
forwarding an even-address data read command to a second storage device;
the first storage device performing the odd-address data read command by skipping even-address data stored in the first storage device and sequentially fetching odd-address data stored in the first storage device for forming a first data stream;
the second storage device performing the even-address data read command by skipping odd-address data stored in the second storage device and sequentially fetching even-address data stored in the second storage device for forming a second data stream; and
performing a data aggregation process on the first data stream and the second data stream for generating a readout data stream.

18. The RAID1 reading method of claim 17, wherein the odd-address data read command and the even-address data read command are performed based on a base reading unit having data stored in a preset sectioned memory space of the first storage device and the second storage device respectively.

19. The RAID1 reading method of claim 17, further comprising:
detecting whether the first storage device is a failed storage device prior to the process of forwarding the odd-address data read command to the first storage device.

20. The RAID1 reading method of claim 17, further comprising:
detecting whether the first storage device is capable of performing the odd-address data read command prior to the process of forwarding the odd-address data read command to the first storage device.

21. The RAID1 reading method of claim 17, further comprising:
detecting whether the second storage device is a failed storage device prior to the process of forwarding the even-address data read command to the second storage device.

22. The RAID1 reading method of claim 17, further comprising:
detecting whether the second storage device is capable of performing the even-address data read command prior to the process of forwarding the even-address data read command to the second storage device.

23. The RAID1 reading method of claim 17, wherein the process of sequentially fetching the odd-address data stored in the first storage device for forming the first data stream is sequentially fetching the odd-address data stored in the first storage device based on a preset data storage unit as a base reading unit for forming the first data stream.

24. The RAID1 reading method of claim 17, wherein the process of sequentially fetching even-address the data stored in the second storage device for forming the second data stream is sequentially fetching the even-address data stored in the second storage device based on a preset data storage unit as a base reading unit for forming the second data stream.
